(19) United States
(12) Patent Application Publication
(10) Pub. No.: US 2026/0148745 A1
(43) Pub. Date: May 28, 2026

(54) SPEECH MODEL PARAMETER INTERPOLATION

(71) Applicant: Digital Voice Systems, Inc., Westford, MA (US)

(72) Inventor: Daniel W. Griffin, Hollis, NH (US)

(21) Appl. No.: 18/962,428

(22) Filed: Nov. 27, 2024

(51) Int. Cl. G10L 19/02; G10L 19/08

(52) U.S. Cl. CPC G10L 19/0204; G10L 19/0212; G10L 19/08

(57) ABSTRACT

This disclosure provides a method of estimating speech model parameters from a digitized speech signal, the method including: dividing the digitized speech signal into two or more frequency band signals; determining a first excitation parameter at a first time sample; determining a second excitation parameter at a second time sample; determining a first weight at the first time sample based on at least one of the first and second modified frequency band signals; determining a second weight at the second time sample based on at least one of the third and fourth modified frequency band signals; determining a third weight at a third time sample based on at least one of the first through fourth modified frequency band signals; determining a third excitation parameter at the third time sample using the first and second excitation parameters and the first, second, and third weights.

### TECHNICAL FIELD

This description relates generally to processing of digital speech.

### BACKGROUND

Speech models, speech analysis, and synthesis methods are widely used in applications such as telecommunications, speech recognition, speaker identification, and speech synthesis. Vocoders, which have been extensively used in practice, are a class of speech analysis/synthesis systems based on an underlying model of speech. Examples of vocoders include linear prediction vocoders, homomorphic vocoders, channel vocoders, sinusoidal transform coders (STC), multi-band excitation (MBE) vocoders, improved multi-band excitation (IMBE™), and advanced multi-band excitation vocoders (AMBE™).

Vocoders may be employed in telecommunications systems, such as mobile radio and cellular telephony, that transmit voice as digital data. Since transmission bandwidth is limited in these systems, the vocoder compresses the voice data to reduce the data that must be transmitted. Similarly, speech recognition, speaker identification, and speech synthesis systems, as well as other voice recording and storage applications, may use digital voice data with a vocoder to reduce the amount of data that must be stored per unit time. In such systems, an analog voice signal from a microphone is converted into a digital waveform using an Analog-to-Digital converter to produce a sequence of voice samples that are processed for further use.

In traditional telephony applications, speech is limited to 3-4 kHz of bandwidth and a sample rate of 8 kHz is used. In higher bandwidth applications, a corresponding higher sampling rate (such as 16 kHz or 32 kHz) may be used. The digital voice signal (i.e., the sequence of voice samples) is processed by the vocoder to reduce the overall amount of voice data. For example, a voice signal that is sampled at 8 kHz with 16 bits per sample results in a total voice data rate of 8,000×16=128,000 bits per second (bps) and a vocoder can be used to reduce the bit rate of this voice signal to rates of 2,000-8,000 bps (i.e., where 2,000 bps is a compression ratio of 64 and 8,000 bps is a compression ratio of 16) being achievable while still maintaining reasonable voice quality and intelligibility. Such large compression ratios are due to the large amount of redundancy within the voice signal and the inability of the ear to discern certain types of distortion. The result is that the vocoder forms a vital part of most modern voice communications systems where the reduction in data rate conserves precious RF spectrum and provides economic benefits to both service providers and users.

A vocoder is divided into two primary functions: (i) an encoder that converts an input sequence of voice samples into a low-rate voice bit stream; and (ii) a decoder that reverses the encoding process and converts the low-rate voice bit stream back into a sequence of voice samples that are suitable for playback via a digital-to-analog converter and a loudspeaker or for other processing.

### SUMMARY

Techniques are provided for estimating or interpolating speech model parameters from a digitized speech signal. The techniques can be implemented in a vocoder. More specifically, the techniques can be implemented in a speech encoder that is a part of the vocoder.

In one general aspect, a method of estimating speech model parameters from a digitized speech signal is disclosed. The digitized speech signal is divided into two or more frequency band signals. A first excitation parameter at a first time sample is determined. To determine the first excitation parameter, a nonlinear operation is performed on at least two of the frequency band signals to produce at least first and second modified frequency band signals. A second excitation parameter at a second time sample is determined. To determine the second excitation parameter, the nonlinear operation is performed on the at least two of the frequency band signals to produce at least third and fourth modified frequency band signals. A first weight at the first time sample is determined based on at least one of the first and second modified frequency band signals. A second weight at the second time sample is determined based on at least one of the third and fourth modified frequency band signals. A third weight at a third time sample is determined based on at least one of the first through fourth modified frequency band signals. A third excitation parameter at the third time sample is determined using the first and second excitation parameters and the first, second, and third weights.

Implementations may include one or more of the following features. For example, in some implementations, the third excitation parameter is a voiced error or a voiced strength.

The third excitation parameter may be closer to the first excitation parameter when the third weight is closer to the first weight.

To divide the digital speech signal into the two or more frequency band signals, a bandpass filter is applied to generate two or more bandpass filter outputs. The nonlinearity operation is applied to each bandpass filter output. Subsequent to applying the nonlinearity operation, a lowpass filter and a downsampling operation are applied to each bandpass filter output.

The bandpass filter may include a Finite Impulse Response (FIR) filter or Infinite Impulse Response (IIR) filter.

To apply the bandpass filter, the digital speech signal may be multiplied by a time window to generate the two or more bandpass filter outputs.

The time window may be a 32 point Kaiser window. A 32 point Fast Fourier transform (FFT) may be used to generate the two or more bandpass filter outputs.

In another general aspect, a method of estimating speech model parameters from a digitized speech signal is disclosed. The digitized speech signal is divided into two or more frequency band signals. A first excitation parameter at a first time sample is determined. To determine the first excitation parameter, a nonlinear operation is performed on at least two of the frequency band signals to produce at least first and second modified frequency band signals. A second excitation parameter at a second time sample is determined. To determine the second excitation parameter, the nonlinear operation is performed on the at least two of the frequency band signals to produce at least third and fourth modified frequency band signals. A first weight at the first time sample is determined based on at least the first and second modified frequency band signals and corresponding voiced strengths. The first weight may be increased when energy in at least one of the first and second modified frequency band signals near the first time sample increases. A second weight at the second time sample is determined based on at least the third and fourth modified frequency band signals and corresponding voiced strengths. The second weight may be increased when energy in at least one of the third and fourth modified frequency band signals near the second time sample increases. A third excitation parameter at a third time sample is determined using the first and second excitation parameters and the first and second weights.

Implementations may include one or more of the following features. For example, in some implementations, the third excitation parameter is a fundamental frequency.

The techniques for determining an interpolation weight and a fundamental frequency used for interpolation or estimation of speech model parameters discussed above and described in more detail below may be implemented by a speech encoder such as a multi-band excitation (MBE) speech encoder. The speech encoder may be included in, for example, a handset, a mobile radio, a base station, or a console.

The details of one or more implementations of the subject matter are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of a vocoder.

FIG. 2 is a block diagram of a speech synthesis system using a multi-band excitation speech model.

FIG. 3 is a block diagram of a speech analysis system for estimating parameters input into the speech synthesis system of FIG. 2.

FIG. 4 is a block diagram of a system for interpolating speech model parameters.

FIG. 5 is a block diagram of the frequency band processing unit of FIG. 4.

FIG. 6 is a block diagram of another system for interpolating speech model parameters.

FIG. 7 is a flowchart of an example process for determining the interpolation weight.

FIGS. 8-10 are flowcharts of a fundamental frequency interpolation process.

FIG. 11 is a flowchart of an example process for estimating speech model parameters from a digitized speech signal.

FIG. 12 is a flowchart of another example process for estimating speech model parameters from a digitized speech signal.

Like reference symbols in the various drawings indicate like elements.

### DETAILED DESCRIPTION

The described techniques can determine an interpolation weight and an interpolated fundamental frequency used for the interpolation of speech model parameters, such as voice strength or voice error, or a vector of voiced parameters associated with the voice strength or voice error. The interpolation of speech model parameters can improve speech coding and compression techniques that rely on quantization to encode speech in a way that permits the output of high-quality speech even when faced with reduced transmission bandwidth or storage constraints. The techniques may be implemented with software. For example, the techniques may be implemented by a speech encoder in a vocoder that is included in, for example, a mobile radio or a cellular telephone.

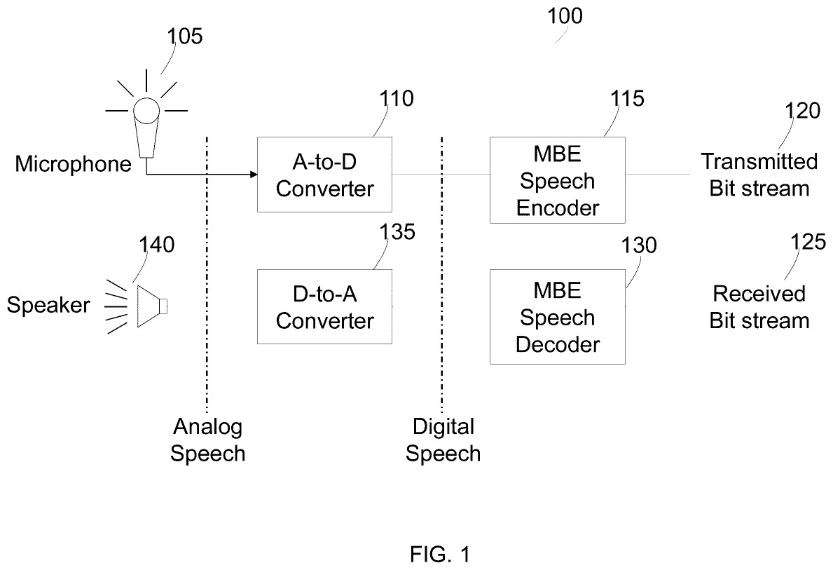

FIG. 1 illustrates a block diagram of a vocoder 100 that samples analog speech or some other signal from a microphone 105. An analog-to-digital (“A-to-D”) converter 110 digitizes the sampled speech to produce a digital speech signal. The digital speech signal is processed by an MBE speech encoder 115 to produce a digital bit stream 120 suitable for transmission or storage.

The speech encoder 115 processes the digital speech samples in short frames. Each frame of digital speech samples produces a corresponding frame of bits in the bit stream output of the speech encoder 115.

FIG. 1 further depicts a received bit stream 125 entering an MBE speech decoder 130 that processes each frame of bits to produce a corresponding frame of synthesized speech samples. A digital-to-analog (“D-to-A”) converter 135 then converts the digital speech samples to an analog signal that can be passed to a speaker 140 for conversion into an acoustic signal suitable for human listening.

Vocoders (e.g., vocoder 100 of FIG. 1) can model speech over a short interval of time as the response of a system excited by some form of excitation. An input signal s₀(n) is obtained by sampling an analog input signal. For applications such as speech coding or speech recognition, the sampling rate ranges, for example, between 6 kHz and 48 kHz. In general, the speech model works well for any sampling rate with corresponding changes in the associated parameters. To focus on a short interval centered at time t, the input signal s₀(n) is multiplied by a window w(t, n) centered at time t to obtain a windowed signal s(t, n). The window used can be a Hanning window or Kaiser window and may have characteristics that change as a function of time or may be time-invariant so that w(t, n)=w₀(nΔ−t) where Δ is the sampling period (reciprocal of the sampling rate). The length of the window w(t, n) ranges between 4 ms and 40 ms. The windowed signal s(t, n) may be computed at center times of t₀, t₁ . . . , tₘ, tₘ₊₁, . . . . The interval between consecutive center times tₘ₊₁-tₘ approximates the effective length of the window w(t, n) used for these center times. The windowed signal s(t, n) for a particular center time may be referred to as a segment or frame of the input signal.

For each segment of the input signal, system parameters and excitation parameters are determined. The system parameters model the spectral envelope or the impulse response of the system. The excitation parameters include a fundamental frequency (or pitch period) and a voiced/unvoiced (V/UV) parameter, which indicates whether the input signal has pitch (or indicates the degree to which the input signal has pitch). For vocoders such as MBE, IMBE, and AMBE, the input signal is divided into frequency bands and the excitation parameters may also include a V/UV decision for each frequency band. High-quality speech reproduction may be provided using a high-quality speech model, accurate estimation of the speech model parameters, and high-quality synthesis methods.

The Fourier transform of the windowed signal s(t, n) may be denoted by S(t, ω) and may be referred to as the signal Short-Time Fourier Transform (STFT). If s(n) is a periodic signal with a fundamental frequency ω₀ or pitch period n₀, the parameters ω₀ and n₀ are related to each other by 2π/ω₀=n₀. Non-integer values of the pitch period no are often used in practice.

In some implementations, a digital speech signal s₀(n) may be divided into multiple frequency bands using bandpass filters. Characteristics of these bandpass filters are allowed to change as a function of time and/or frequency. In some implementations, a speech signal may also be divided into multiple bands by applying frequency windows or weightings to the speech signal STFT S(t, ω).

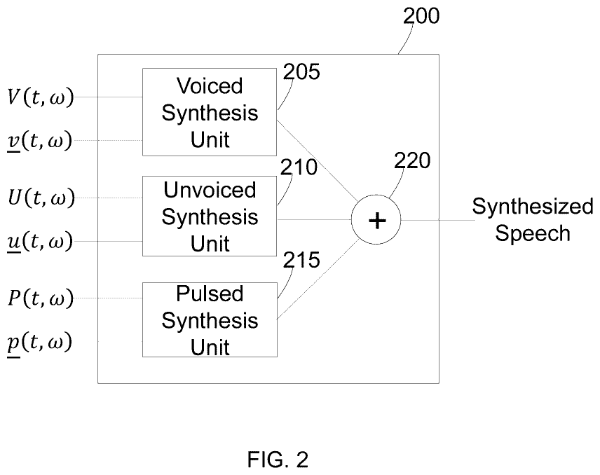

FIG. 2 is a block diagram of a speech synthesis system using a multi-band excitation speech model. The speech synthesis system 200 of FIG. 2 can be a part of MBE speech decoder 130 of FIG. 1. Referring to FIG. 2, the speech synthesis system 200 including a multi-band excitation speech model is disclosed in U.S. Pat. No. 6,912,495, entitled “Speech Model and Analysis, Synthesis, and Quantization Methods,” which is incorporated by reference in its entirety. This speech model augments the typical excitation parameters (e.g., fundamental frequency parameter of the voiced excitation) with additional parameters (e.g., V(t, ω), v(t, ω), U(t, ω), u(t, ω), P(t, ω), p(t, ω)) for higher-quality speech synthesis. Speech synthesis system 200 includes a voiced synthesis unit 205 that receives a voiced strength parameter V(t, ω) and an associated vector of parameter v(t, ω) and uses them to produce a quasi-periodic “voiced” audio signal, an unvoiced synthesis unit 210 that receives an unvoiced strength parameter U(t, ω) and an associated vector of parameters u(t, ω) and uses them to produce a noise-like “unvoiced” audio signal, and a pulsed synthesis unit 215 that receives a pulsed strength parameter P(t, ω) and an associated vector of parameters p(t, ω) and uses them to produce a pulsed audio signal. A summation unit 220 adds the audio signals produced by these units to produce synthesized speech. Methods for synthesizing these three signals are disclosed in U.S. Pat. No. 6,912,495.

The voiced strength V(t, ω), unvoiced strength U(t, ω), and pulsed strength P(t, ω) parameters control the proportion of quasi-periodic, noise-like, and pulse-like signals in each frequency band. These parameters are functions of time (t) and frequency (ω). The voiced strength parameter V(t, ω) may vary between zero, which indicates that there is no voiced signal at time t and frequency ω, and one, which indicates that the signal at time t and frequency ω is entirely voiced. The unvoiced strength and pulsed strength parameters provide similar indications. The excitation strength parameters may be constrained in the speech synthesis system 200 so that they sum to one (i.e., V(t, ω)+U(t, ω)+P(t, ω)=1).

The vector of parameters v(t, ω) associated with the voiced strength parameter V(t, ω) includes voiced excitation parameters and voiced system parameters. The voiced excitation parameters may include a time and frequency-dependent fundamental frequency ω₀(t, ω) (or equivalently a pitch period n₀(t, ω)).

The vector of parameters u(t, ω) associated with the unvoiced strength parameter U(t, ω) includes unvoiced excitation parameters and unvoiced system parameters. The unvoiced excitation parameters may include, for example, statistics and energy distribution.

The vector of parameters p(t, ω) associated with the pulsed excitation strength parameter P(t, ω) includes pulsed excitation parameters and pulsed system parameters. The pulsed excitation parameters may include one or more pulse positions n₀(t, ω) and amplitudes.

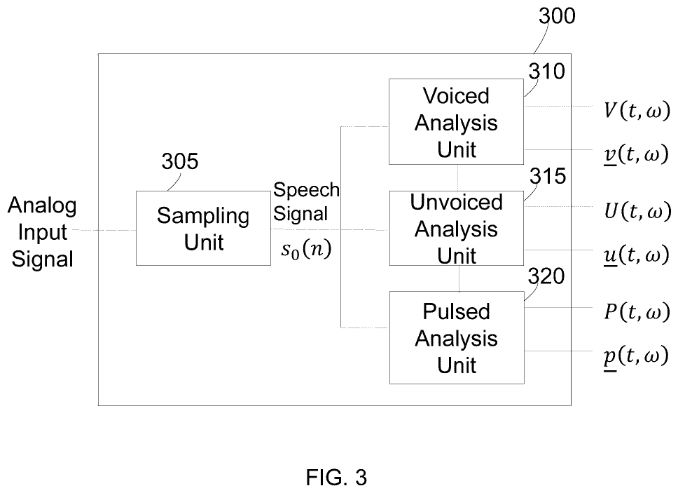

FIG. 3 is a block diagram of a speech analysis system for estimating parameters input into the speech synthesis system of FIG. 2. The speech analysis system 300 of FIG. 3 can be a part of MBE speech encoder 115 of FIG. 1.

Referring to FIG. 3, a speech analysis system 300 estimates speech model parameters from an analog input signal. The speech analysis system 300 includes a sampling unit 305, a voiced analysis unit 310, an unvoiced analysis unit 315, and a pulsed analysis unit 320. The sampling unit 305 samples an analog input signal to produce a speech signal s₀(n). In some implementations, the sampling unit 305 may operate remotely from the analysis units 310, 315, and 320. As to speech coding or recognition applications, the sampling rate can range between 6 kHz and 48 kHz. The voiced analysis unit 310 estimates the voiced strength V(t, ω) and the voiced parameters v(t, ω) from the speech signal s₀(n). The unvoiced analysis unit 315 estimates the unvoiced strength U(t, ω) and the unvoiced parameters u(t, ω) from the speech signal s₀(n). The pulsed analysis unit 320 estimates the pulsed strength P(t, ω) and the pulsed signal parameters p(t, ω) from the speech signal s₀(n). The analysis units 310, 315, and 320 are interconnected such that information flows between these analysis units 310, 315, and 320 to improve parameter estimation performance.

In some implementations, only the voiced strength V(t, ω) and pulsed strength P(t, ω) are estimated. The unvoiced strength U(t, ω) can be inferred from the voiced and pulsed strengths V(t, ω) and P(t, ω).

Analysis units 310, 315, and 320 are disclosed in U.S. Pat. No. 6,912,495, which, as noted above, has been incorporated by reference. Voiced strength analysis involves determining how periodic the signal is in a frequency band and time interval. Pulsed strength analysis involves determining how pulse-like the signal is in a frequency band and time interval. For example, the time interval for pulsed strength analysis is the frame length.

In some implementations, as to voiced strength analysis, a longer time interval is generally used to span multiple periods for low fundamental frequencies. Thus, for low fundamental frequencies, it is possible to have periodic pulses over the voiced analysis time interval but only a single pulse in the pulsed analysis time interval. Consequently, it is possible for the speech analysis system 300 to produce a high pulsed strength estimate and a high voiced strength estimate for the same frequency band and center time.

In many applications, reduction of computational requirements is desirable to meet real-time constraints in a particular hardware implementation or reduce power requirements. A technique for reducing computational requirements is to perform voiced analysis less often and interpolate the resulting voiced strength and voiced parameters. U.S. Pat. No. 6,377,916, entitled “Multi-band Harmonic Transform Coder,” incorporated herein in its entirety, discloses an interpolation method. The interpolation method interpolates a fundamental frequency for the current frame using the geometric mean of the fundamental frequency estimated in the next frame and the fundamental frequency estimated in the previous frame. The voicing decisions are interpolated for the current frame using a logical OR operation of the voicing decisions estimated for the next frame and the voicing decisions estimated for the previous frame. The techniques disclosed in U.S. Pat. No. 6,377,916 result in an interpolation method that favors voiced decisions over unvoiced decisions.

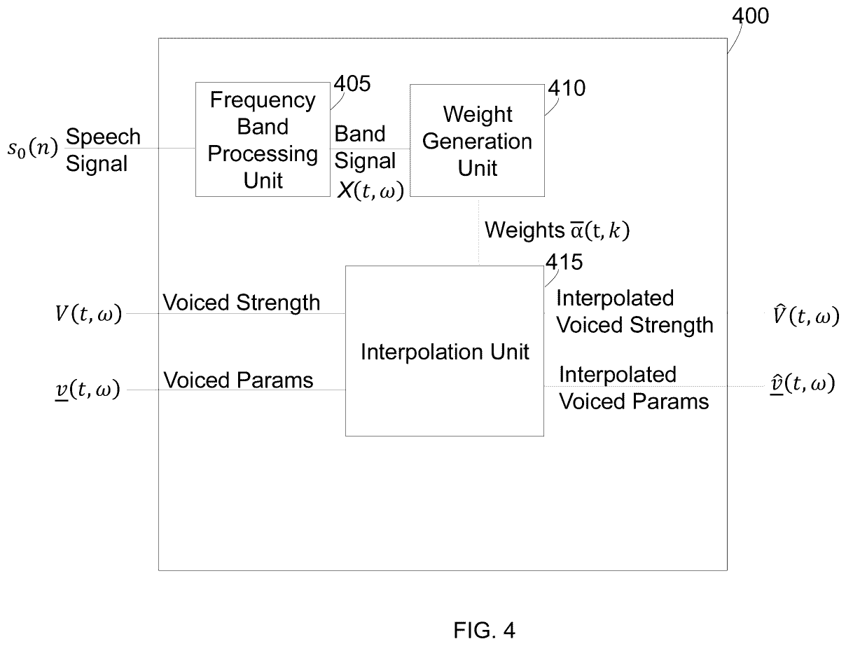

FIG. 4 is a block diagram of a system for interpolating speech model parameters. The voiced strength and voiced parameters interpolation system 400 of FIG. 4 can also be a part of MBE speech encoder 115 of FIG. 1. The voiced strength V(t, ω) and the voiced parameters v(t, ω) output from the speech analysis system 300 of FIG. 3 are input into the interpolation unit 415 of FIG. 4. The speech signal s₀(n) in FIG. 3 can also be input into the frequency band processing unit 405 of FIG. 4. Referring to FIG. 4, a voiced strength and voiced parameters interpolation system 400 includes a frequency band processing unit 405, a weight generation unit 410, and an interpolation unit 415. Voiced strength and voiced parameters interpolation system 400 allows voicing analysis to be performed less often by providing interpolated voiced strength \hat{V}(t, ω) and interpolated voiced parameters \hat{v}(t, ω) based on the speech signal s₀(n) as well as voiced strength V(t, ω) and voiced parameters v(t, ω) provided by voiced analysis unit 310 of FIG. 3. The frequency band processing unit 405 divides the speech signal s₀(n) into multiple frequency bands. To reduce computation, frequency band processing unit 405 may use previously-computed results from voiced analysis unit 310 of FIG. 3 such as the filter bank output. Weight generation unit 410 generates weights based on the frequency band data produced by frequency band processing unit 405. Interpolation unit 415 computes interpolated voiced strength \hat{V}(t, ω) and interpolated voiced parameters v(t, ω) based on voiced strength V(t, ω) and voiced parameters v(t, ω) output from the voiced analysis unit 310 of FIG. 3 and weights output by weight generation unit 410.

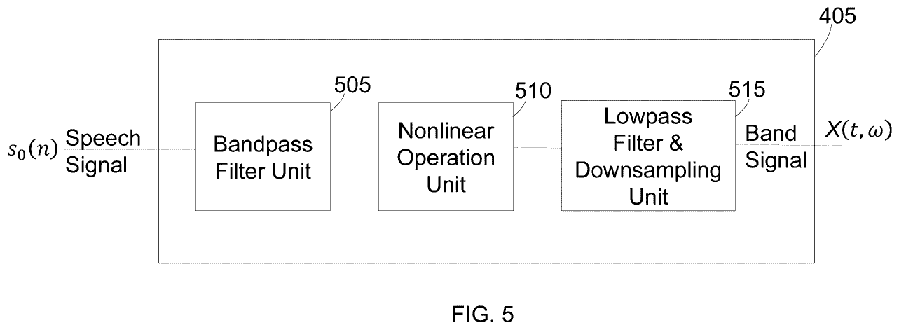

FIG. 5 is a block diagram of the frequency band processing unit 405 of FIG. 4. Referring to FIG. 5, a frequency band processing unit 405 may be implemented as a channel processing unit disclosed in U.S. Pat. No. 5,826,222 entitled “Estimation of Excitation Parameters,” which is incorporated herein in its entirety. The frequency band processing unit 405 includes a bandpass filter unit 505, a nonlinear operation unit 510, and a lowpass filter and downsampling unit 515. Bandpass filter unit 505 can be implemented as a Finite Impulse Response (FIR) or Infinite Impulse Response (IIR) filter. In some implementations, the speech signal S₀(n) is multiplied by a window such as a 32 point Kaiser window with parameter 5.0, and a 32 point Fast Fourier transform (FFT) is used to compute bandpass filter outputs at 17 center frequencies. Downsampling of the bandpass filter outputs can be achieved by shifting the window by S samples each time the FFT is computed where S is set to, e.g., 4. Nonlinear operation unit 510 applies a nonlinearity such as the absolute value to each bandpass filter output. For the real bandpass filter with a center frequency of zero, half-wave rectification can be used to zero the negative portion of the signal. Lowpass filter and downsampling unit 515 applies a lowpass filter to the output of nonlinear operation unit 510. The band signal output X(t, ω) of the lowpass filter can be computed every other sample to apply a downsampling operation which reduces computation and storage requirements. The time sampling rate of band signal output X(t, ω) is, e.g., 1 kHz, and the frequency sampling interval is, e.g., 250 Hz.

In some implementations, the band signal output X(t, ω) can be computed in voiced analysis unit 310 of FIG. 3 as a part of a process of estimating the fundamental frequency ω₀(t, ω) and voiced strength V(t, ω). The band signal output X(t, ω) can be used directly in the voiced strength and voiced parameters interpolation system 400, and thus the frequency band processing unit 405 can be omitted or skipped.

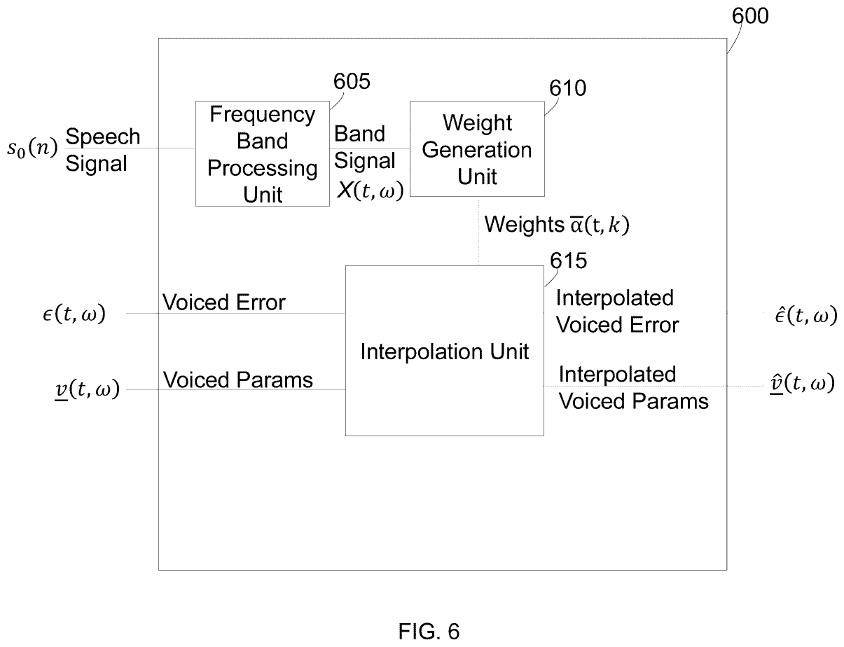

FIG. 6 is a block diagram of another system for interpolating speech model parameters. Referring to FIG. 6, a voiced error and voiced parameters interpolation system 600 includes a frequency band processing unit 605, a weight generation unit 610, and an interpolation unit 615, which are alternatives to the frequency band processing unit 405, weight generation unit 410, and interpolation unit 415 of FIG. 4. Voiced error and voiced parameters interpolation system 600 allows voicing analysis to be performed less often by providing interpolated voiced error \hat{∈}(t, ω) and interpolated voiced parameters \hat{v}(t, ω) based on the speech signal s₀(n) as well as voiced error ∈(t, ω) (calculated according to Equation (1) below) and voiced parameters v(t, ω) provided by voiced analysis unit 310. The voiced strength V(t, ω) may be computed from the voiced error ∈(t, ω). The difference between FIG. 4 and FIG. 6 lies in the input to interpolation unit 415 or 615. In FIG. 4, voiced strength V(t, ω) is input into interpolation unit 415, while in FIG. 6, voiced error ∈(t, ω) is input into interpolation unit 615.

The frequency band processing unit 605 divides the speech signal s₀(n) into multiple frequency bands X(t, ω). In some implementations, to reduce computation, the band signal output X(t, ω) can be computed in voiced analysis unit 310 of FIG. 3 as a part of a process of estimating the fundamental frequency ω₀(t, ω) and voiced strength V(t, ω). The band signal output X(t, ω) can be used directly in the voiced error and voiced parameters interpolation system 600 and thus the frequency band processing unit 605 can be omitted or skipped.

Weight generation unit 610 generates weights based on the frequency band data X(t, ω) produced by frequency band processing unit 605. Interpolation unit 615 computes interpolated voiced error \hat{∈} (t, ω) and interpolated voiced parameters \hat{v} (t, ω) based on voiced error ∈(t, ω), voiced parameters v(t, ω) and weights produced by weight generation unit 610. The voiced error ∈(t, ω) varies between zero and one. A voiced error of zero indicates a strongly voiced (periodic) frequency band signal X(t, ω). A voiced error above a threshold T (e.g., 0.2) indicates the frequency band signal is not voiced or only weakly voiced. In one implementation disclosed in U.S. Pat. No. 5,826,222 entitled “Estimation of Excitation Parameters,” a voiced energy Eᵥ(t, ω) and a total energy E_{T}(t, ω) are computed from the frequency band signals based on the estimated fundamental frequency ω₀(t, ω). A voiced error ∈(t, ω) can be computed by voiced analysis unit 310 using a voiced energy Eᵥ(t, ω) and a total energy E_{T}(t, ω) according to Equation (1).

$$ϵ ( t , ω ) = 1 - {E}_{v} ( t , ω ) / {E}_{T} ( t , ω ) \qquad ( 1 )$$

When the total energy E_{T}(t, ω) is zero, the voiced error ∈(t, ω) can be set to one to avoid division by zero in Equation (1).

In some implementations, weight generation unit 610 generates weights by multiplying the frequency band signal X(t, ω) by a window and summing according to Equation (2).

$$α ( t , ω ) = {\sum }_{n} {w}_{1} ( t , n ) X ( {t}_{n} , ω ) \qquad ( 2 )$$

The window used may be a tapered window or a rectangular window and is constant as a function of time t so that w₁(t, n)=w₂(nΔ−t). The length of the window can range between 5 ms and 40 ms. In some examples, a rectangular window has a length of 10 ms. n is an index to time samples of X(tₙ, ω) and an index to the window w₁(t, n). For example, if X(tₙ, ω) is sampled at 1 KHz, n=0, 1, 2, 3, . . . , accordingly, tₙ=0 ms, 1 ms, 2 ms, 3 ms.

In some implementations, interpolation unit 615 has voiced error ∈(t, ω) inputs computed every 20 ms with 8 frequency bands. Example band edges for these 8 frequency bands for an 8 kHz sampling rate are 0 Hz, 375 Hz, 875 Hz, 1375 Hz, 1875 Hz, 2375 Hz, 2875 Hz, 3375 Hz, and 4000 Hz. The output of weight generation unit 610 is computed by combining adjacent frequency samples according to Equation (3).

$$\overline{α} ( t , k ) = α ( t , {ω}_{2 k} ) + α ( t , {ω}_{2 k + 1} ) \qquad ( 3 )$$

The frequency band index k varies from 0 to 7, and the center frequencies of the weights combined are k*500 Hz and k*500+250 Hz. Since weight generation unit 610 has low computational complexity, the outputs may be computed at a smaller sampling interval (e.g., 10 ms) without a significant increase in the computation complexity of the speech coding system (e.g., MBE speech encoder 115 of FIG. 1).

In some implementations, the interpolated voiced error \hat{∈}(t, ω) can be computed from the voiced error ∈(t, ω) and an interpolation weight γ(tₙ, k) according to Equation (4).

$$\hat{ϵ} ( {t}_{n} , {ω}_{k} ) = γ ( {t}_{n} , k ) ϵ ( {t}_{n - 1} , {ω}_{k} ) + ( 1 - γ ( {t}_{n} , k ) ) ϵ ( {t}_{n + 1} , {ω}_{k} ) \qquad ( 4 )$$

The voiced error ∈(t, ω) inputs are available at time samples tₙ₋₁ and tₙ₊₁ (e.g., tₙ₊₁−tₙ₋₁=20 ms). The time sample for which an interpolated voiced error \hat{∈}(t, ω) is desired is tₙ (e.g., tₙ−tₙ₋₁=10 ms). The interpolation weight γ(tₙ, k) varies between zero and one, and can be computed from the weights α̅(t, k), which are computed using Equations (2) and (3).

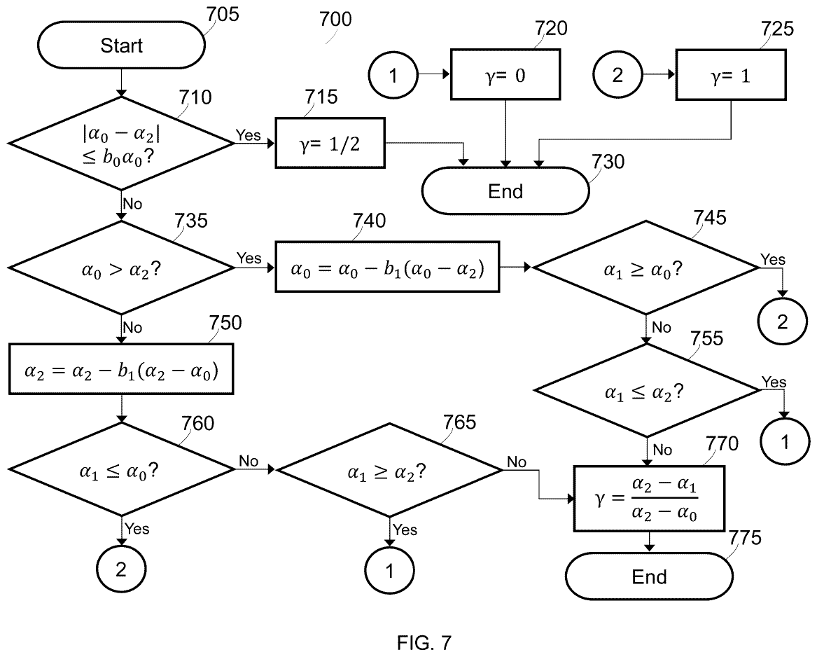

FIG. 7 illustrates an example process for determining the interpolation weight γ(tₙ, k). The symbol for the interpolation weight γ(tₙ, k) is shortened to γ for legibility in FIG. 7. The process 700 can be executed for calculating an interpolated voiced error for each frequency band index k and each time sample tₙ. Before process 700 starts, the following variables are initialized:

$${α}_{0} = \overline{α} ( {t}_{n - 1} , k ) \qquad ( 5 )$$

$${α}_{1} = \overline{α} ( {t}_{n} , k ) \qquad ( 6 )$$

$${α}_{2} = \overline{α} ( {t}_{n + 1} , k ) \qquad ( 7 )$$

Referring to FIG. 7, a process 700 starts at 705. At 710, the absolute value of the difference between the weights at the previous time sample do and the next time sample α₂ is compared to the product of a constant b₀ (e.g., 0.4) and the weight at the previous time sample α₀. If the absolute value of the difference between the weights at the previous time sample α₀ and the next time sample α₂ is less than or equal to the product of a constant b₀ and the weight at the previous time sample α₀, the process 700 proceeds to 715. Otherwise, the process 700 proceeds to 735.

At 715, the interpolation weight γ is set to ½ and the process 700 proceeds to 730 which ends the process 700.

At 735, the weight at the previous time sample do is compared with the weight at the next time sample α₂. If the weight at the previous time sample α₀ is greater than the weight at the next time sample α₂, the process 700 proceeds to 740. Otherwise, the process 700 proceeds to 750.

At 740, the weight α₀ is reduced by the product of a constant b₁ (e.g., 0.67) and the difference between weight α₀ and weight α₂ and the process 700 proceeds to 745.

At 745, the weight at the current time sample α₁ is compared with the weight α₀. If the weight α₁ is greater than or equal to the weight α₀, the process 700 proceeds to 725. Otherwise, the process 700 proceeds to 755.

At 725, the interpolation weight γ is set to 1, and the process 700 proceeds to 730 which ends the process 700.

At 755, the weight at the current time sample α₁ is compared with the weight α₂. If the weight α₁ is less than or equal to the weight α₂, the process 700 proceeds to 720. Otherwise, the process 700 proceeds to 770.

At 720, the interpolation weight γ is set to 0, and the process 700 proceeds to 730 which ends the process.

At 770, the interpolation weight γ is set to the ratio between the difference of weight α₂ and weight α₁ and the difference of weight α₂ and weight do and the process 700 proceeds to 775 which ends the process 700.

At 750, the weight α₂ is reduced by the product of a constant b₁ (e.g., 0.67) and the difference between weight α₂ and weight α₀, and the process 700 proceeds to 760.

At 760, the weight at the current time sample α₁ is compared with the weight α₀. If the weight α₁ is less than or equal to the weight α₀, the process 700 proceeds to 725. Otherwise, the process 700 proceeds to 765.

At 765, the weight at the current time sample α₁ is compared with the weight α₂. If the weight α₁ is greater than or equal to the weight α₂, the process 700 proceeds to 720. Otherwise, the process 700 proceeds to 770.

In some implementations of interpolation unit 415 or 615, the input voiced parameters v(t, ω) include an estimated fundamental frequency ω₀(t) with a sampling interval of, e.g., 20 ms.

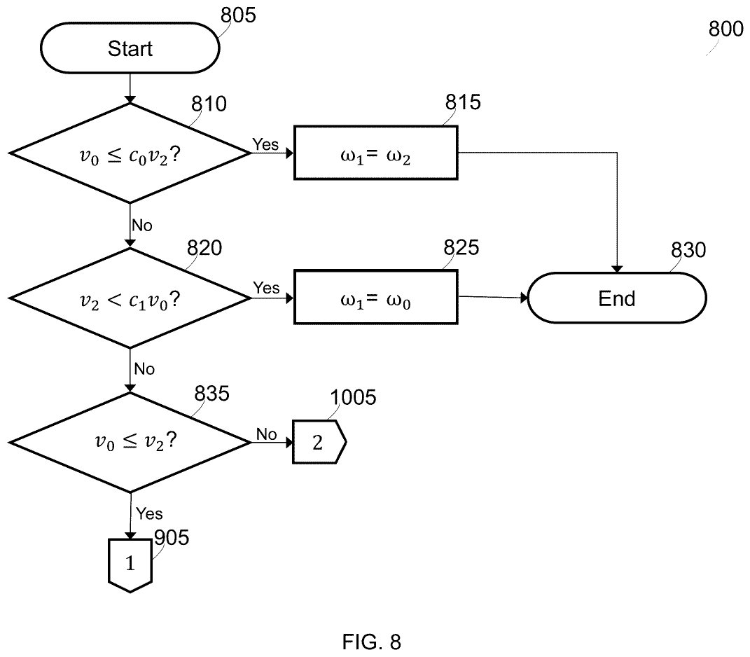

FIGS. 8-10 illustrate an example process for interpolating the estimated fundamental frequency ω₀(t). Referring to FIG. 8, a sub-process 800 starts at 805. At 810, a voiced weight v₀ for the previous time sample tₙ₋₁ is compared to the product of a constant c₀ (e.g., 0.5) and a voiced weight v₂ for the next time sample tₙ₊₁. For example, a voiced weight αᵥ(t) can be computed as a voiced strength vₛ(t, k) weighted summation of the weights α̅(t, k) (output from weight generation unit 410 in FIG. 4 or 610 in FIG. 6) over a frequency band index k according to Equation (8).

$${α}_{v} ( t ) = {\sum }_{k} {v}_{s} ( t , k ) \overline{α} ( t , k ) \qquad ( 8 )$$

The voiced strength vₛ(t, k) can be computed from the voiced error ∈(t, ωₖ) and a threshold T (e.g., 0.2) according to Equation (9).

$${v}_{s} ( t , k ) = \{ \begin{matrix}0. , ϵ ( t , {ω}_{k} ) \geq T \\ 1. - ϵ ( t , {ω}_{k} ) / T , ϵ ( t , {ω}_{k} ) < T\end{matrix} \qquad ( 9 )$$

A voiced weight v₀ can be set to αᵥ(tₙ₋₁) and a voiced weight v₂ can be set to αᵥ(tₙ₊₁). If a voiced weight v₀ is less than or equal to the product of a constant c₀ and a voiced weight 12, the sub-process 800 proceeds to 815. Otherwise, the sub-process 800 proceeds to 820.

At 815, the interpolated fundamental frequency ω₁ is set to the fundamental frequency estimate ω₂. In some implementations, a fundamental frequency estimate ω₂ is set to estimated fundamental frequency ω₀(tₙ₊₁). The sub-process 800 then proceeds to 830 which ends the process. ω₀ is an output of voiced analysis unit 310 and an input to interpolation unit 615 at time tₙ₋₁, ω₂ is an output of voiced analysis unit 310 and an input to interpolation unit 615 at time tₙ₊₁, and ω₁ is an output of interpolation unit 615 at time tₙ. For example, tₙ₊₁−tₙ₋₁=20 ms and tₙ−tₙ₋₁=10 ms.

At 820, a voiced weight v₂ is compared to the product of a constant c₁ (e.g., 0.5) and a voiced weight v₀. If a voiced weight v₂ is less than the product of a constant c₁ and a voiced weight v₀, the sub-process 800 proceeds to 825. Otherwise, the sub-process 800 proceeds to 835.

At 825, the interpolated fundamental frequency ω₁ is set to the fundamental frequency estimate ω₀. In some implementations, fundamental frequency estimate ω₀ is set to an estimated fundamental frequency ω₀(tₙ₋₁). The sub-process 800 then proceeds to 830 which ends the process.

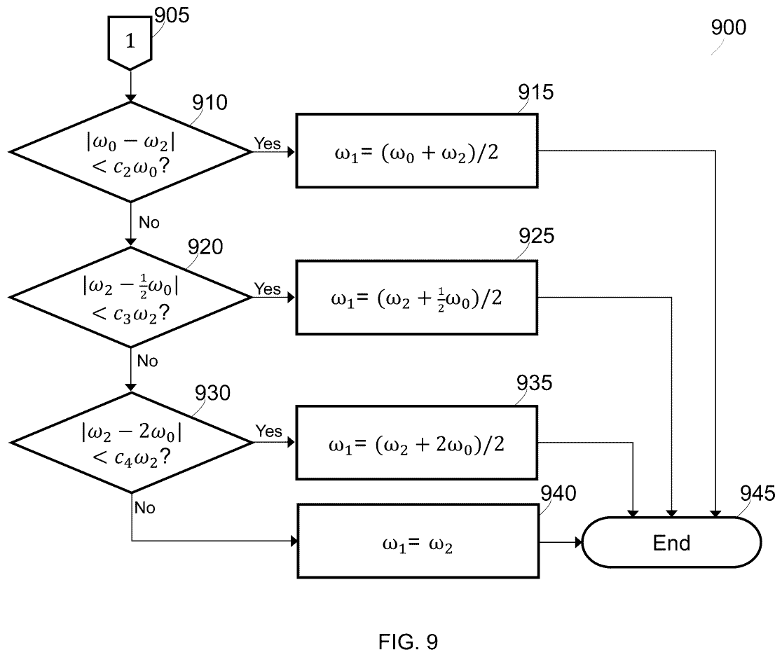

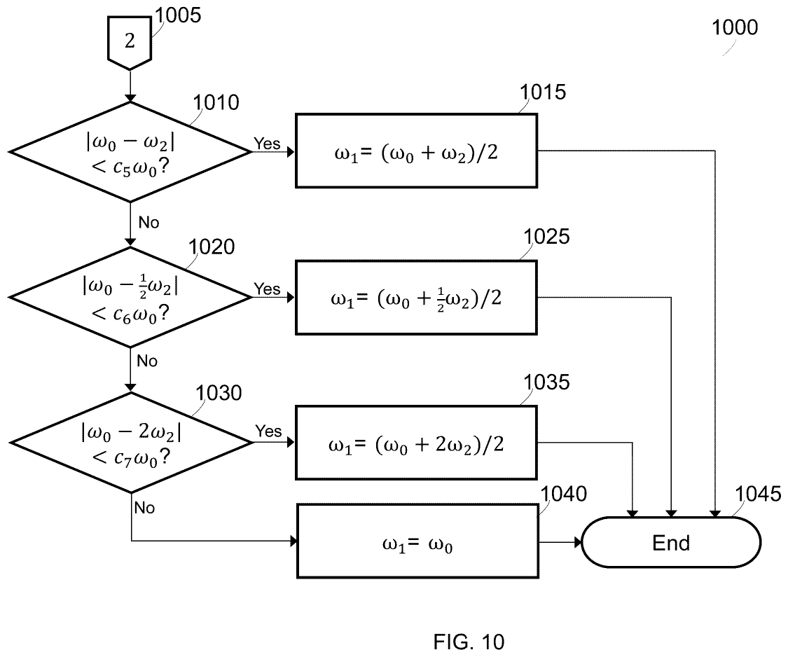

At 835, a voiced weight v₀ is compared to a voiced weight v₂. If a voiced weight v₀ is less than or equal to a voiced weight v₂, the sub-process 800 proceeds to 905 of sub-process 900 shown in FIG. 9. Otherwise, the sub-process 800 proceeds to 1005 of sub-process 1000 shown in FIG. 10.

Referring to FIG. 9, sub-process 900 begins at 905 and proceeds to 910.

At 910, the absolute value of the difference between a fundamental frequency estimate ω₀ and a fundamental frequency estimate ω₂ is compared to the product of a constant c₂ (e.g., 0.2) and a fundamental frequency estimate ω₀. If the absolute value is less than the product of a constant c₂ and a fundamental frequency estimate ω₀, the sub-process 900 proceeds to 915. Otherwise, the sub-process 900 proceeds to 920.

At 915, the interpolated fundamental frequency ω₁ is set to the average of a fundamental frequency estimate ω₀ and a fundamental frequency estimate ω₂ and the sub-process 900 proceeds to 945 which ends the process.

At 920, the absolute value of the difference between a fundamental frequency estimate ω₂ and half the fundamental frequency estimate ω₀ is compared to the product of a constant c₃ (e.g., 0.2) and a fundamental frequency estimate ω₂. If the absolute value is less than the product of a constant c₃ and a fundamental frequency estimate ω₂, the sub-process 900 proceeds to 925. Otherwise, the sub-process 900 proceeds to 930.

At 925, the interpolated fundamental frequency ω₁ is set to the average of a fundamental frequency estimate ω₂ and half a fundamental frequency estimate ω₀ and the sub-process 900 proceeds to 945 which ends the process.

At 930, the absolute value of the difference between a fundamental frequency estimate ω₂ and twice a fundamental frequency estimate ω₀ is compared to the product of a constant c₄ (e.g., 0.2) and a fundamental frequency estimate ω₂. If the absolute value is less than the product of a constant c₄ and a fundamental frequency estimate ω₂, the sub-process 900 proceeds to 935. Otherwise, the sub-process 900 proceeds to 940.

At 935, the interpolated fundamental frequency ω₁ is set to the average of a fundamental frequency estimate ω₂ and twice a fundamental frequency estimate w₀ and the sub-process 900 proceeds to 945 which ends the process.

At 940, the interpolated fundamental frequency ω₁ is set to a fundamental frequency estimate ω₂ and the sub-process 900 proceeds to 945 which ends the process.

Referring to FIG. 10, sub-process 1000 begins at 1005 and proceeds to 1010.

At 1010, the absolute value of the difference between a fundamental frequency estimate ω₀ and a fundamental frequency estimate ω₂ is compared to the product of a constant c₅ (e.g., 0.2) and a fundamental frequency estimate ω₀. If the absolute value is less than the product of a constant c₅ and a fundamental frequency estimate ω₀, the sub-process 1000 proceeds to 1015. Otherwise, the sub-process 1000 proceeds to 1020.

At 1015, the interpolated fundamental frequency ω₁ is set to the average of a fundamental frequency estimate ω₀, and a fundamental frequency estimate ω₂ and the sub-process 1000 proceeds to 1045 which ends the process.

At 1020, the absolute value of the difference between a fundamental frequency estimate ω₀ and half the fundamental frequency estimate ω₂ is compared to the product of a constant c₆ (e.g., 0.2) and a fundamental frequency estimate ω₀. If the absolute value is less than the product of a constant c₆ and a fundamental frequency estimate ω₀, the sub-process 1000 proceeds to 1025. Otherwise, the sub-process 1000 proceeds to 1030.

At 1025, the interpolated fundamental frequency ω₁ is set to the average of a fundamental frequency estimate ω₀ and half a fundamental frequency estimate ω₂ and the sub-process 1000 proceeds to 1045 which ends the process.

At 1030, the absolute value of the difference between a fundamental frequency estimate ω₀ and twice a fundamental frequency estimate ω₂ is compared to the product of a constant c₇ (e.g., 0.2) and a fundamental frequency estimate ω₀. If the absolute value is less than the product of a constant c₇ and a fundamental frequency estimate ω₀, the sub-process 1000 proceeds to 1035. Otherwise, the sub-process 1000 proceeds to 1040.

At 1035, the interpolated fundamental frequency ω₁ is set to the average of a fundamental frequency estimate ω₀ and twice a fundamental frequency estimate ω₂ and the sub-process 1000 proceeds to 1045 which ends the process.

At 1040, the interpolated fundamental frequency @1 is set to a fundamental frequency estimate ω₀ and the sub-process 1000 proceeds to 1045 which ends the process.

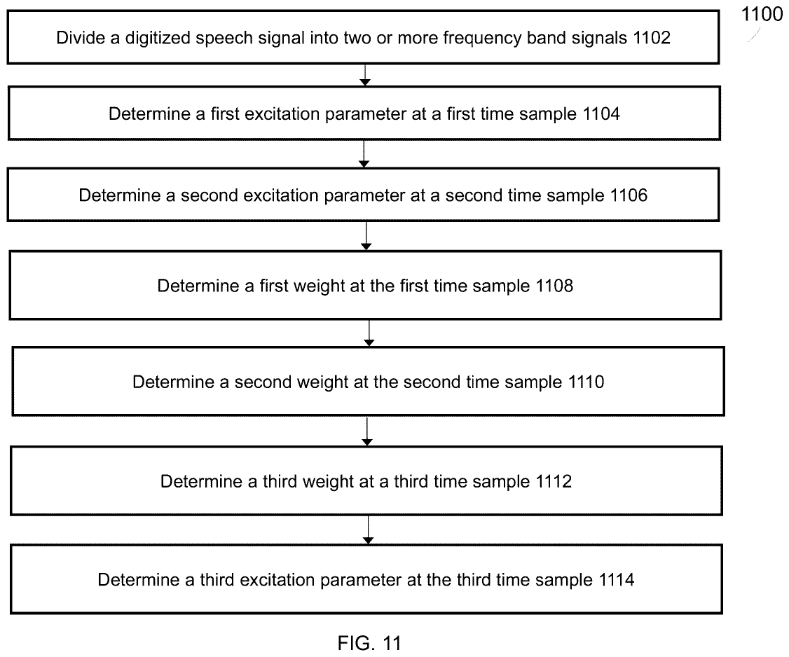

FIG. 11 is a flowchart of an example process for estimating speech model parameters from a digitized speech signal. The process 1100 can be implemented in MBE speech encoder 115 of FIG. 1. More particularly, the process 1100 can be implemented in speech analysis system 300 and voiced strength and voiced parameters interpolation system 400 (or voiced error and voiced parameters interpolation system 600), which are parts of MBE speech encoder 115 of FIG. 1. At 1102, voiced analysis unit 310 divides a digitized speech signal (e.g., speech signal S₀(n)) into two or more frequency band signals. Voiced analysis unit 310 is disclosed in U.S. Pat. No. 5,715,365, entitled “Estimation of Excitation Parameters,” which is incorporated by reference in its entirety. Voiced analysis unit 310 can divide a digitized speech signal into multiple frequency band signals, similar to the function of frequency band processing unit 405.

At 1104, voiced analysis unit 310 determines a first excitation parameter (e.g., voiced strength V(t, ω) or voiced error ∈(t, ω)) at a first time sample (e.g., previous time sample tₙ₋₁). The determination can be implemented at least by performing a nonlinear operation on at least two of the frequency band signals to produce at least first and second modified frequency band signals (e.g., frequency band signal X(t, ω)).

In some implementations, voiced analysis unit 310 can include multiple nonlinear operation units that are similar to nonlinear operation unit 510. The multiple nonlinear operation units can perform a nonlinear operation.

At 1106, voiced analysis unit 310 determines a second excitation parameter (e.g., voiced strength V(t, ω) or voiced error ∈(t, ω)) at a second time sample (e.g., the next time sample tₙ₊₁). The determination can be implemented at least by performing a nonlinear operation on the at least two of the frequency band signals signals to produce at least third and fourth modified frequency band signals (e.g., frequency band signal X(t, ω)).

At 1108, weight generation unit 410 or 610 determines a first weight (e.g., weight α₀) at the first time sample (e.g., previous time sample tₙ₋₁) based on at least one of the first and second modified frequency band signals (e.g., frequency band signal X(t, ω)).

At 1110, weight generation unit 410 or 610 determines a second weight (e.g., weight α₂) at the second time sample (e.g., the next time sample tₙ₊₁) based on at least one of the third and fourth modified frequency band signals (e.g., frequency band signal X(t, ω)).

At 1112, weight generation unit 410 or 610 determines a third weight (e.g., weight α₁) at a third time sample (e.g., the current time sample or interpolated time sample tₙ) based on at least one of the first through fourth modified frequency band signals (e.g., frequency band signal X(t, ω)).

At 1114, interpolation unit 415 or 615 determines a third excitation parameter (e.g., voiced strength V(t, ω) or voiced error ∈(t, ω)) at the third time sample (e.g., the current time sample or interpolated time sample tₙ) using the first and second excitation parameters and the first, second, and third weights (e.g., weights α₀, α₃, α₁).

In some implementations, the third excitation parameter is closer to the first excitation parameter when the third weight (e.g., α₁) is closer to the first weight (e.g., α₀). Referring to FIG. 7, when α₁ is close to α₀, at 770, γ close to 1 or at 725, Y=1. When γ is close to 1, Equation (4) sets the third excitation parameter closer to the first excitation parameter.

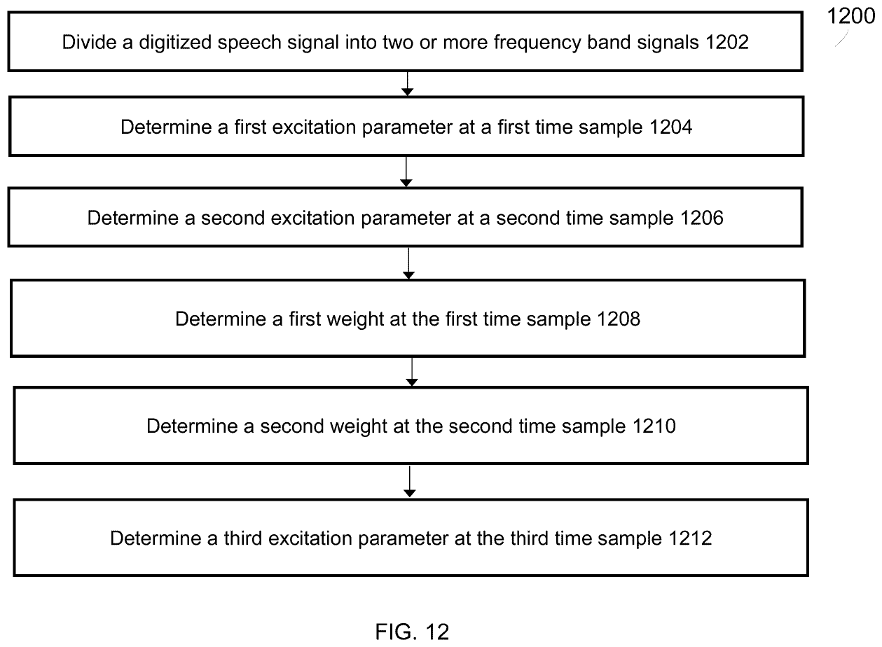

FIG. 12 is a flowchart of another example process for estimating speech model parameters from a digitized speech signal. The process 1200 can be implemented in MBE speech encoder 115 of FIG. 1. More particularly, the process 1200 can be implemented in speech analysis system 300 and voiced strength and voiced parameters interpolation system 400 (or voiced error and voiced parameters interpolation system 600), which are parts of MBE speech encoder 115 of FIG. 1.

At 1202, similar to 1102, voiced analysis unit 310 divides a digitized speech signal (e.g., speech signal S₀(n)) into two or more frequency band signals. Voiced analysis unit 310 can divide a digitized speech signal into multiple frequency band signals, similar to the function of frequency band processing unit 405.

At 1204, similar to 1104, voiced analysis unit 310 determines a first excitation parameter (e.g., ω₀(tₙ₋₁) or ω₀) at a first time sample (e.g., previous time sample tₙ₋₁). The determination can be implemented at least by performing a nonlinear operation on at least two of the frequency band signals to produce at least first and second modified frequency band signals (e.g., frequency band signal X(t, ω)).

At 1206, similar to 1106, voiced analysis unit 310 determines a second excitation parameter (e.g., ω₀(tₙ₊₁) or ω₂) at a second time sample (e.g., the next time sample tₙ₊₁). The determination can be implemented at least by performing a nonlinear operation on the at least two of the frequency band signals to produce at least third and fourth modified frequency band signals (e.g., frequency band signal X(t, ω)).

At 1208, weight generation unit 410 or 610 determines a first weight (e.g., weight α₀) at the first time sample (e.g., previous time sample tₙ₋₁) based on at least the first and second modified frequency band signals (e.g., frequency band signal X(t, ω)) and corresponding voiced strengths (e.g., voiced strength V(t, ω)). The determination can be implemented at least by increasing the first weight (e.g., weight α₀) when energy in at least one of the first and second modified frequency band signals near the first time sample (e.g., previous time sample tₙ₋₁) increases. This is because voiced weight v₀ is a voiced strength weighted sum of the weights α̅(t, k) (Equation (8)) and α₀=α̅(tₙ₋₁, k) (Equation (5)).

At 1210, weight generation unit 410 or 610 determines a second weight (e.g., weight α₂) at the second time sample (e.g., the next time sample tₙ₊₁) based on at least the third and fourth modified frequency band signals (e.g., frequency band signal X(t, ω)) and corresponding voiced strengths (e.g., voiced strength V(t, ω)). The determination can be implemented at least by increasing the second weight (e.g., weight α₂) when energy in at least one of the third and fourth modified frequency band signals near the second time sample (e.g., the next time sample tₙ₊₁) increases. This is because voiced weight v₀ is a voiced strength weighted sum of the weights α̅(t, k) (Equation (8)) and ω₂=α̅(tₙ₊₁, k) (Equation (7)).

At 1212, interpolation unit 415 or 615 determines a third excitation parameter (e.g., ω₀(tₙ) or ω₁) at a third time sample (e.g., the current time sample or interpolated time sample tₙ) using the first and second excitation parameters and the first and second weights (weights α₀, α₂). ω₁ is an element of the interpolated voiced parameters \hat{v} (t, ω) output in FIGS. 4 and 6.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Although the implementations above have been described in considerable detail, numerous variations and modifications will become apparent to those skilled in the art once the above disclosure is fully appreciated. It is intended that the following claims be interpreted to embrace all such variations and modifications.

1. A method of estimating speech model parameters from a digitized speech signal, the method comprising:
dividing the digitized speech signal into two or more frequency band signals;
determining a first excitation parameter at a first time sample, wherein determining the first excitation parameter comprises performing a nonlinear operation on at least two of the frequency band signals to produce at least first and second modified frequency band signals;
determining a second excitation parameter at a second time sample, wherein determining the second excitation parameter comprises performing the nonlinear operation on the at least two of the frequency band signals to produce at least third and fourth modified frequency band signals;
determining a first weight at the first time sample based on at least one of the first and second modified frequency band signals;
determining a second weight at the second time sample based on at least one of the third and fourth modified frequency band signals;
determining a third weight at a third time sample based on at least one of the first through fourth modified frequency band signals;
determining a third excitation parameter at the third time sample using the first and second excitation parameters and the first, second, and third weights.

2. The method of claim 1, wherein the third excitation parameter is a voiced error or a voiced strength.

3. The method of claim 1, wherein the third excitation parameter is closer to the first excitation parameter when the third weight is closer to the first weight.

4. A method of estimating speech model parameters from a digitized speech signal, the method comprising:
dividing the digitized speech signal into two or more frequency band signals;
determining a first excitation parameter at a first time sample, wherein determining the first excitation parameter comprises performing a nonlinear operation on at least two of the frequency band signals to produce at least first and second modified frequency band signals;
determining a second excitation parameter at a second time sample, wherein determining the second excitation parameter comprises performing the nonlinear operation on the at least two of the frequency band signals to produce at least third and fourth modified frequency band signals;
determining a first weight at the first time sample based on at least the first and second modified frequency band signals and corresponding voiced strengths, wherein determining the first weight comprises increasing the first weight when energy in at least one of the first and second modified frequency band signals near the first time sample increases;
determining a second weight at the second time sample based on at least the third and fourth modified frequency band signals and corresponding voiced strengths, wherein determining the second weight comprises increasing the second weight when energy in at least one of the third and fourth modified frequency band signals near the second time sample increases;
determining a third excitation parameter at a third time sample using the first and second excitation parameters and the first and second weights.

5. The method of claim 4, wherein the third excitation parameter is a fundamental frequency.

6. The method of claim 1, wherein dividing the digital speech signal into the two or more frequency band signals further comprises:
applying a bandpass filter to generate two or more bandpass filter outputs;
applying the nonlinearity operation to each bandpass filter output; and
subsequent to applying the nonlinearity operation, applying a lowpass filter and a downsampling operation to each bandpass filter output.

7. The method of claim 6, wherein the bandpass filter comprises a Finite Impulse Response (FIR) filter or Infinite Impulse Response (IIR) filter.

8. The method of claim 6, wherein applying the bandpass filter comprises multiplying the digital speech signal by a time window to generate the two or more bandpass filter outputs.

9. The method of claim 8, wherein the time window is a 32 point Kaiser window, and a 32 point Fast Fourier transform (FFT) is used to generate the two or more bandpass filter outputs.

10. A speech encoder configured to perform the method of claim 1.

11. A handset or mobile radio comprising the speech encoder of claim 10.

12. A base station or console comprising the speech encoder of claim 10.

13. A speech encoder configured to perform the method of claim 4.

14. A handset or mobile radio comprising the speech encoder of claim 13.

15. A base station or console comprising the speech encoder of claim 13.
